(19) United States
(12) Patent Application Publication
(10) Pub. No.: US 2025/0375631 A1
(43) Pub. Date: Dec. 11, 2025

(54) HARNESS GEAR LOOP

(71) Applicant: Amer Sports Canada Inc., North Vancouver (CA)

(72) Inventors: Gordon T. Rose, Bowen Island (CA); Jason Jeremy Mah, Vancouver (CA); Michael L. Foley, Vancouver (CA); Timothy Babcock, Vancouver (CA)

(73) Assignee: Amer Sports Canada Inc., North Vancouver, BC (CA)

(21) Appl. No.: 18/736,175

(22) Filed: Jun. 6, 2024

(51) Int. Cl. A62B 35/00

(52) U.S. Cl. CPC A62B 35/0025; A62B 35/0006

(57) ABSTRACT

A harness gear loop is disclosed for use with a harness having a waist belt and a structural core having spaced portions secured to the belt and a central portion between the spaced portions. The harness gear loop may include a core sheath having a groove configured to removably receive the central portion of the structural core while the core sheath extends along and about the structural core. A core retainer selectively retains the core sheath along and about the structural core with the central portion of the structural core residing within the groove and selectively releases the core sheath from the structural core with the central portion removed from the groove while the spaced portions remain secured to the belt.

### BACKGROUND

Harnesses may have a variety of different sizes, shapes and configurations. Harnesses may be used for positioning, suspension and fall protection. Harnesses may be used for activities such as climbing, rappelling, zip lining, bungee jumping and hunting or wildlife observation. During hunting (or wildlife observation) the hunter may use a harness to suspend himself or herself from a tree or other supporting structure.

Some harnesses are equipped with gear loops. The gear loops extend from and are formed along an outer side of a waist belt of the harness. The gear loops may be utilized to hold various pieces of equipment. For example, when the harness is a climbing harness, the gear loops may be utilized to hold and carry carabiners, extra rope, lock rings and the like during ascent or descent.

### BRIEF DESCRIPTION OF THE DRAWINGS

FIG. 1A is a front perspective view illustrating portions of an example harness comprising an example waist belt comprising example gear loops.

FIG. 1B is a front perspective view illustrating portions of an example harness comprising an example waist belt comprising the example gear loops.

FIG. 2 is a fragmentary sectional view of the example harness of FIG. 1A or FIG. 1B comprising an example gear loop having an example structural core, an example sheath, a first set of example core retainers and a second set of example core retainers, wherein FIG. 2 illustrates the first set of example core retainers being mounted to the sheath.

FIG. 3 is a sectional view of the example gear loop of FIG. 2 taken along line 3-3.

FIG. 4 is a side view illustrating the example harness of FIG. 2.

FIG. 5 is a sectional view of the gear loop of FIG. 2 taken along line 3-3 with the second set of example core retainers mounted to the sheath.

FIG. 6 is a side view illustrating the example harness of FIG. 5.

FIG. 7 is a fragmentary sectional view of the example harness of FIG. 1A or FIG. 1B with an example gear loop having a set of example core retainers mounted to an example sheath in waist belt standoff positions.

FIG. 8 is a sectional view of the example harness of FIG. 7 taken along line 8-8.

FIG. 9 is a side view of the example harness of FIG. 7.

FIG. 10 is a sectional the example harness of FIG. 7 with the set of core retainers mounted to the sheath in vertical hanging positions.

FIG. 11 is a side view of the example harness of FIG. 10.

FIG. 12 is a diagram illustrating the example sheath and core retainers of FIG. 2 and the example sheath and core retainers of FIG. 7 separated and removed from a structural core suspended from the waist belt.

FIG. 13 is a perspective view of an example harness with an example gear loop suspended from an example waist belt in a standoff position.

FIG. 14 is a perspective view of the example harness of FIG. 13.

FIG. 15 is an exploded perspective view of the example harness of FIG. 13.

FIG. 16 is a fragmentary perspective view illustrating separation of an example core retainer from an example sheath positioned about an along an example structural core of the example gear loop of FIG. 13.

FIG. 17 is a fragmentary perspective view illustrating separation of an example core retainer from an example sheath positioned about an along an example structural core of the example gear loop of FIG. 13.

FIG. 18 is an enlarged fragmentary perspective view of the example gear loop of FIG. 13 illustrating an end portion of the example sheath receiving the example structural core.

FIG. 19 is a fragmentary perspective view illustrating separation of an example core retainer from an example sheath positioned about an along an example structural core of the example gear loop of FIG. 13.

FIG. 20 is a fragmentary perspective view illustrating separation of an example core retainer from an example sheath positioned about an along an example structural core of the example gear loop of FIG. 13.

FIG. 21 is a perspective view of the example core retainer of the example gear loop of FIG. 13.

FIG. 22 is a perspective view of the example core retainer of the example gear loop of FIG. 13.

FIG. 23 is a perspective view illustrating the example gear loop of the example harness of FIG. 13.

FIG. 24 is a side view illustrating the example harness of FIG. 13 with the example gear loop in standoff positions.

FIG. 25 is a perspective view illustrating the example harness of FIG. 13 with the example core retainers mounted to the example sheath in vertical hanging positions.

FIG. 26 is a side view of the example harness of FIG. 25 with the

example core retainers mounted to the example sheath in the vertical hanging positions.

FIG. 27 is a fragmentary perspective view of an example harness having an example removable gear loop core cover system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

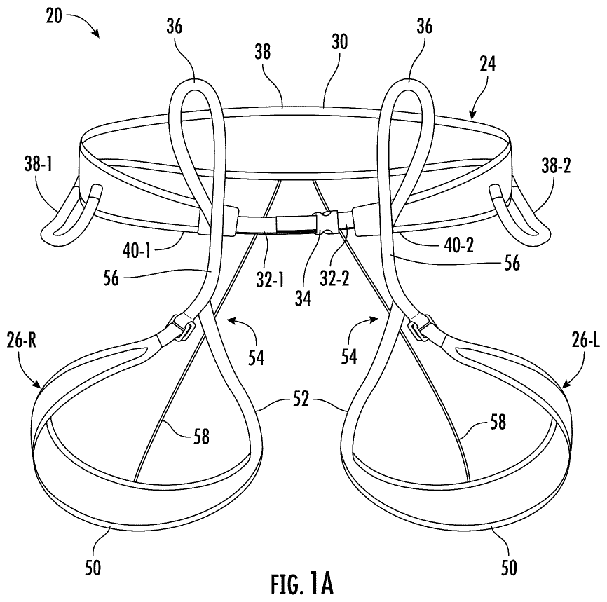

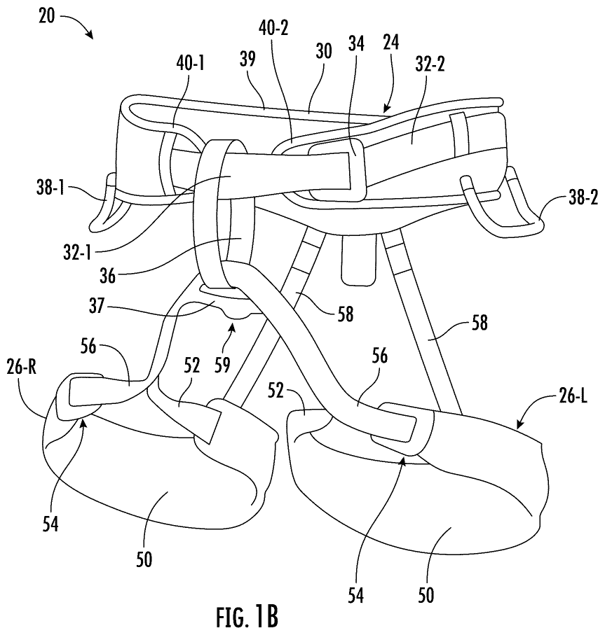

FIG. 1A and FIG. 1B illustrate two different examples of a harness 20 having gear loops 38-1 and 38-2 (collectively referred to as gear loops 38) that facilitate customization of the gear loops and repair/replacement of the gear loops. Each of the example harnesses 20 comprises three primary components: a waist belt 24 (sometimes referred to as a “swami”) and a pair of leg loops 26-R and 26-L (collectively referred to as leg loops 26). In some implementations, harness 20 may comprise additional primary components that encircle or wrap about the shoulders and/or chest of the person wearing harness 20. Although the present invention is shown incorporated into a climbing harness, the invention is also applicable to other harnesses and packs. Waist belt 24 is configured to support leg loops 26 from the waist of a person wearing harness 20. Waist belt 24 is further configured to be attached to a tether, rope, cable or other flexible line from which waist belt 24 may be suspended from an upper support to limit an extent to which waist belt 24 and the person wearing harness 20 may fall from the upper support. Waist belt 24 comprises wide band portion 30, narrow extension portions 32-1, 32-2 (collectively referred to as narrow extension portions 32), connector 34, tether support line connectors 36 and gear loops 38-1, 38-2 (collectively referred to as gear loops 38).

Wide band portion 30 comprises an elongate band configured to wrap about the waist of the person wearing harness 20. Wide band portion 30 has a width so as to distribute forces along a larger surface area (as compared to a single straight line) to providing enhanced comfort to the person wearing harness 20. Wide band portion 30 has a nonuniform width along its length, being wider along a rear portion 39 and narrower along front-end portions 40-1, 40-2. In some implementations, wide band portion 30 is configured to rest upon the iliac crest of a person's hip bones. In such implementations, wide band portion 30 may have a curved configuration similar to that of a banana.

Narrow extension portions 32-1 and 32-2 extend from front end portions 40-140-2, respectively, of wide band portion 30. Narrow extension portions 32 each have a width less than that of rear portion 39 and, in the example illustrated, less than at least portions of front-end portions 40. In the example illustrated, narrow extension portions 32 comprise straps that are each joined to connector 34. In the example illustrated in which connector 34 comprises a buckle or pair rungs, wherein at least one of narrow extension portions 32 is configured to thread through the rungs or the buckle to provide an adjustable length for waist belt 24.

Connector 34 releasably connects narrow extension portions 32 to secure waist belt 24 about the waist of the person wearing harness 20. In the example illustrated, connector 34 comprises a quick disconnect connector in the form of a side release buckle. In the example illustrated, the side release buckle is joined to narrow extension portions 32-1 to provide narrow extension portions 32-1 with an adjustable length extending between front-end portions 40-1 and connector 34. In other implementations, narrow extension portions 32-1 may be joined to connector 34 with a fixed length between end portions 40-1 and connector 34. In yet other implementations, connector 34 may comprise other forms of a connector.

Tether support line connector 36, sometimes referred to as a belay loop such as shown in FIG. 1A, provides a connection point for a tether support line, in the form of a rope, cable, strap or the like configured to be suspended from an upper support. Referring to FIG. 1B, tether support line connector 36 comprises the two loops formed by upper end portions of the narrow extension portions 56 of the leg loops 26, wherein the tether support line is “tied into” the two loops. In some implementations, such loops may be formed from materials such as nylon, polyester, ultra-high molecular weight yarns, liquid crystal polymers such as VECTRAN, or other fibers.

Gear loops 38 comprise loops extending from wide band portion 30. Gear loops 38 are configured to be attached to various pieces of gear that may be hung from waist belt 24. In the example illustrated, each of gear loops 38 comprises a flexible cord having opposite ends secured to sides of wide band portion 30. In other implementations, gear loops 38 may be formed by metal loops or metal rings secured to wide band portion 30. In some implementations, gear loops 38 may have other configurations and may be secured to different portions of wide band portion 30. In some implementations, waist belt 24 may include additional gear loops 38.

Leg loops 26-R and 26-L extend from and are suspended from the right and left front sides, respectively, of waist belt 24. Leg loops 26-R and 26-L are configured to be wrapped about the right and left thighs, respectively, of the person wearing harness 20. Leg loops 26 are substantially identical to one another. Leg loops 26 each comprise wide band portion 50, narrow extension portion 52, connector 54, narrow extension portion 56 and leg loop riser 58.

Wide band portion 50 comprises a wide band configured to underlie a person's thighs while spreading or distributing forces across a wider surface area to provide enhanced comfort to the thighs of the person wearing harness 20. Wide band portion 50 has a nonuniform width along its length, tapering as it approaches each of narrow extension portions 52 and 56. In such implementations, wide band portion 50 may have a curved configuration similar to that of a banana. Wide band portion has a minimum widest width of 43 mm when used as part of a waist belt and a minimum widest width of 43 mm when employed as part of a leg loop.

Narrow extension portion 52 extends from wide band portion 50 so as to extend along an inner thigh of the person wearing harness 20. Narrow extension portion 52 provides a length that may be more flexible, bendable or twistable as compared to wide band portion 50. In the example illustrated, narrow extension portion 52 has a maximum transverse width that is no greater than 75% to of the maximum transverse width of wide band portion 50.

Connector 54 releasably connects an end of narrow extension portion 52 to narrow extension portion 56 so as to complete the loop about the person's thigh. Connector 54 is configured to provide further adjustability for the size of the leg loops 26 to accommodate differently sized thighs.

In other implementations, connector 54 may comprise a buckle, a quick disconnect or other connection mechanism that facilitates the adjustment of the length of narrow extension portion 52 between wide band portion 50 and narrow extension portion 56. In some implementations, connector 54 may affix an end of narrow extension portion 52 to narrow extension portion 56. In each of such implementations, narrow tension portion 52 may alternatively be adjustably or non-adjustably connected to an end portion of wide band portion 50.

Narrow extension portion 56 extends from wide band portion 50 and is joined or connected to waist belt 24. Narrow extension portions 56 of leg loops 26 are joined to one another (or are part of a single integral strap, band, cord or the like) that passes through tether support line connector 36 (belay loop 36). Referring to FIG. 1B, each of narrow extension portions 56 can be further interconnected by a cross piece 37 to form a tie-in point or loop 59. In other implementations, narrow extension portion 56 is connected to waist belt 24 in other fashions.

Leg loop risers 58 comprises straps, cords or the like which each have a first end connected to an underside of respective leg loops 26 (the underside of wide band portion 50), and a second end connected to a rear of waist belt 24 (rear portion 39 of wide band portion 30). Leg loop risers 38 assist in supporting and suspending leg loops 26 from waist belt 24.

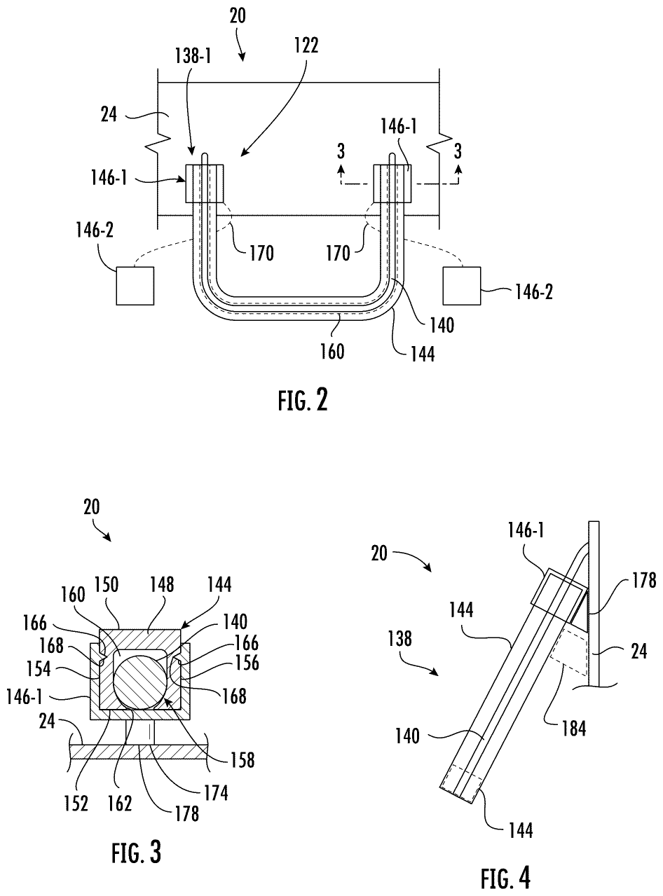

FIG. 2 is a front view illustrating an example gear loop 138, which may be used as gear loop 38-1 and 38-2 in the example harness 20 shown in FIG. 1. Gear loop 138 is suspended from waist belt 24. Gear loop 138 comprises structural core 140, core sheath 144 and core retainers 146-1, 146-2 (collectively referred to as core retainers 146).

Structural core 140 comprises an elongate member which serves as the spine for gear loop 138. Structural core 140 hangs from waist belt 24. In the example illustrated, structural core 140 has opposite end portions secured to waist belt 24 by stitching, welds, adhesives or the like. In the example illustrated, structural core 140 may comprise elongate flexible cord or strap having opposite ends secured to waist belt 24 at spaced locations. The structural core 140 is formed of a high tensile strength material, such as, for example, a woven or braided synthetic material including one or more of nylon, polypropylene, polyester, polyethylene. In some implementations, the structural core 140 can be an engineered webbing or a flat braid. In one implementation, the structural core can have a width of approximately 5 mm and a thickness of approximately 1.5 mm. In other implementations, the structural core 140 can have a width within the range of 1 to 8 mm, and a thickness also within the range of 1 to 8 mm. The core 140 can have a cross-sectional shape that is circular, ovular, rectangular, square, other polygonal shapes or an irregular shape. In some implementations, core 140 is sufficiently flexible such that it takes the shape of core sheath 144 when core sheath 144 receives core 140. In other implementations, core 140 may be sufficiently rigid with a predefined shape corresponding to the shape of core sheath 144. In other implementations, core 140 may be formed from other materials and have other configurations.

Core sheath 144 and the one or more core retainers 146 form a removable gear loop core cover system. Core sheath 144 comprises an outer covering configured to at least partially surround and receive core 140. Core sheath 144 has a degree of rigidity or stiffness greater than that of core 140 and/or is formed from material having a greater degree of abrasion resistance as compared to core 140. Core sheath 144 releasably or removably receives core 140. As a result, core sheath 144 may be separated from core 140 for repair, replacement or exchange with a differently configured core sheath 144. Core sheath 144 may be formed from a recyclable material, such as a thermoplastic polyurethane. As a result, in such implementations, core sheath 144 may be independently reused or recycled when separated from harness 20. In some implementations, core sheath 144 is formed from a material such as, for example, other thermoplastic polymers, nylon, polypropylene, polyvinyl chloride and combinations thereof.

As shown by FIGS. 2 and 3, in the example illustrated, core sheath 144 comprise a U-shaped body 148 having top 150, a bottom 152, an inner side 154 and an outer side 156. When sheath 144 is mounted to core 140 and is hanging from waist belt 24, top 150 faces in a direction away from waist belt 24 and away from the person wearing waist belt 24. Conversely, when sheath 144 is mounted to core 140 and is hanging from waist belt 24, bottom 152 faces in a direction towards waist belt 24 and towards the person wearing waist belt 24.

Body 148 further comprises a groove 158 extending into bottom 152. In the example illustrated, groove 158 extends along the bottom 152 of sheath 144, wherein articles attached to the gear loop 130-1 extend over and in contact with top 150 of sheath 144. In the illustrated example, groove 158 has an interior 160 sized to receive core 140 and a mouth 162 having a width less than that of the interior and less than the diameter or width of core 140, wherein portions of sheath 144 along mouth 162 are resiliently flexible so as to flex and bend when core 140 is being inserted into interior 160 through mouth 162. Once core 140 has been inserted into interior 160, such portions along mouth 162 resiliently return to their initial shape to maintain core 140 in interior 160 until core retainers 146 can more securely retain core 140 in place. In other implementations, opening 162 of groove 158 has a width equal to or greater than the width of interior 160 to facilitate easier insertion of core 140 into groove 158.

Core retainers 146 comprise structures configured to selectively retain core 140 within sheath 144. In the example illustrated, core retainers 146 are located at opposite ends of core sheath 144. In other implementations, core retainers 146 may be replaced with a single core sheath that extends across a midpoint of sheath 144. In some implementations, the single core retainer 146 extends from one end to the other end of sheath 144.

Each of core retainers 146 is configured to extend across and at least partially cover mouth 162 to inhibit core 140 from exiting sheath 144 through mouth 162. In the example illustrated, each of core retainers 146 is releasably snapped in place across mouth 162. In the example illustrated, end portions of each of core retainers 146 comprises opposing male projections 166 configured to snap into corresponding female recesses 168 formed on the exterior of body 148 of sheath 144. Each core retainers 146 is resiliently flexible to facilitate resilient deformation or bending of such end portions to withdraw projections 166 from recesses 168, permitting sheath 144 to be repositioned or moved so as to uncover mouth 162, permitting sheath 144 to be removed from core 140.

In the example illustrated, each of core retainers 146 is completely separable from sheath 144. As a result, core retainers 146 may be repaired or replaced as needed. In other implementations, each of core retainers 146 (or the single core retainer when provided) may be movably secured to sheath 144 when moved to a mouth opening position so as to not be detached from sheath 144. For example, in some implementations, each of core retainers 146 may be connected to sheath 144 by a flexible tether 170 (shown in broken lines) so as to dangle from sheath 144 when not snapped to sheath 144. Such a tether 170 may prevent core retainers 146 from being dropped or otherwise lost. In some implementations, the tethers 170 may be integrally formed as part of a single unitary body with the respective core retainers 146. In other implementations, tethers 170 may be co-molded with core retainers 146 or bonded, welded or otherwise connected to core retainers 146.

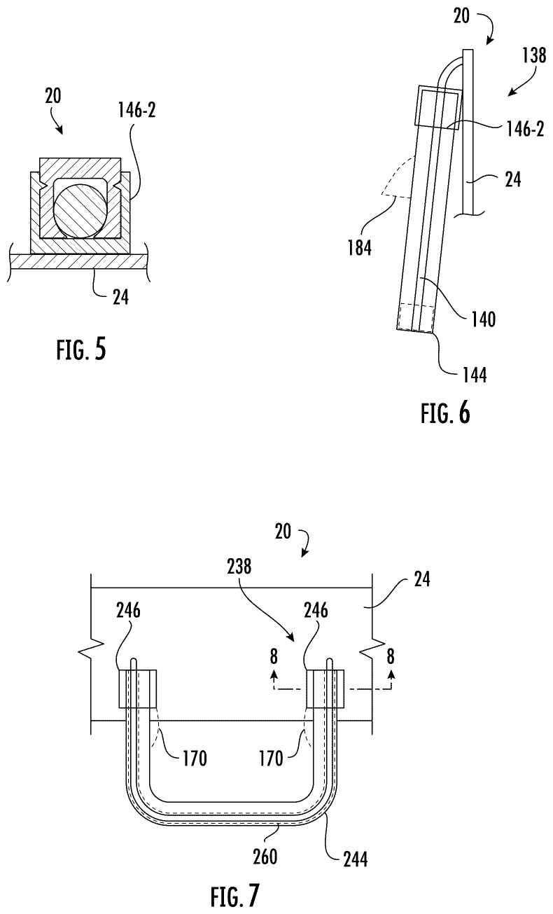

FIGS. 3-6 illustrate the use of the two different interchangeable core retainers 146-1 and 146-2. FIGS. 3 and 4 illustrate a first type of core retainer 146-1 being used. FIGS. 5 and 6 illustrate a second type of core retainer 146-2 being used. Core retainer 146-1 is different from core retainer 146-2 in that core retainer is 146-1 additionally comprises a standoff 174.

Standoff 174 comprises a structure projecting from the bottom 152 that is configured to butt against an exterior face of waist belt 24 so as to hold sheath 144 at an outwardly angled position extending away from waist belt 24. In the example illustrated, standoff 174 comprises a ramp surface 178 that contacts waist belt 24 so as to support one sheath 144 at an outwardly angled position as shown in FIG. 4. In other implementations, standoff 174 may have other shapes and configurations. For example, standoff 174 may comprise a finger or other non-ramp projections. Because standoff 174 spaces sheath 144 from waist belt 24, articles suspended by gear loop 138 are held away from waist belt 24 and away from the body the person wearing waist belt 24.

Core retainers 146-2 omit standoff 174. As a result, as shown by FIG. 6, gear loop 138 is able to hang closer to waist belt 24 and closer to the body of the person wearing waist belt 24. Use of core retainers 146-2 may reduce a likelihood of the gear loop 138 inadvertently catching on external objects.

In some implementations, gear loop 138 is in the form of a kit that includes both of core retainers 146-1 and core retainers 146-2, wherein the user may selectively use the set of core retainers 146-1 or the set of core retainers 146-2 depending on whether he or she wishes the gear loop 130-1 to be supported away from his or her body or to hang more closely to his or her body. In some implementations, one set of core retainers 146-1, 146-2 may be permanently or releasably secured to sheath 144 by a tether while the other set of core retainers 146-1, 146-2 is completely separated and distinct from sheath 144 (not secured by a tether). In some implementations, both of core retainers 146-1 and 146-2 may be joined to sheath 144 by respective tethers 117, wherein those core retainers 146-1, 146-2 not being used simply hang from sheath 144 while the other core retainers that are being used are snapped to sheath 144 as shown in FIG. 3 or FIG. 5.

As shown by broken lines in FIGS. 4 and 6, in some implementations, sheath 144 may additionally or alternatively comprise a standoff 184. Standoff 184 may comprise ramp structures or posts which extend on opposite sides of mouth 162, on an opposite side of groove 158. Standoff 184 may be releasably snapped or connected to sheath 144 or may be integrally formed as part of a singer unitary body with sheath 144.

As shown by FIG. 4, standoff 184 is located so as to butt against waist belt 24 to space the remainder sheath 144 from waist belt 24 such that gear loop 138 extends or projects away from waist belt 24 and away from the body of the person wearing harness 20. As shown by FIG. 6, sheath 144 may be separated from core 140 and reversed/flipped such that standoff 184 faces away from waist belt 24 and no longer spaces sheath 144 away from waist belt 24. As a result, gear loop 130-1 may hang more closely to waist belt 24 and closer to the body of the person wearing harness 20. In those implementations where sheath 144 comprises standoff 184, retainers 146-1 may omit standoff 146-1 while still providing the person wearing harness 20 with the options of the standoff configuration shown in FIG. 4 and the non-standoff configuration shown in FIG. 6.

FIGS. 7-11 illustrate harness 20 with gear loop 238. Gear loop 238 may be used as gear loop 38-1 and/or gear loop 38-2 in the example harness 20 shown in FIG. 1. Gear loop 238 is suspended from waist belt 24. Gear loop 238 comprises structural core 140 (described above), core sheath 244 and core retainers 246.

Core sheath 244 and core retainers 246 form a removable gear loop core cover system. Core sheath 244 comprises an outer covering configured to at least partially surround and receive core 140. Core sheath 244 has a degree of rigidity or stiffness greater than that of core 140 and/or is formed from material having a greater degree of abrasion resistance as compared to core 140. Core sheath 244 releasably or removably receives core 140. As a result, core sheath 244 may be separated from core 140 for repair, replacement or exchange with a differently configured core sheath 144. Core sheath 244 may be formed from a recyclable material, such as a thermoplastic polymer. As a result, in such implementations, core sheath 244 may be independently reused or recycled when separated from harness 20. In some implementations, core sheath 244 is formed from a material such as nylon, polypropylene and polyvinyl chloride.

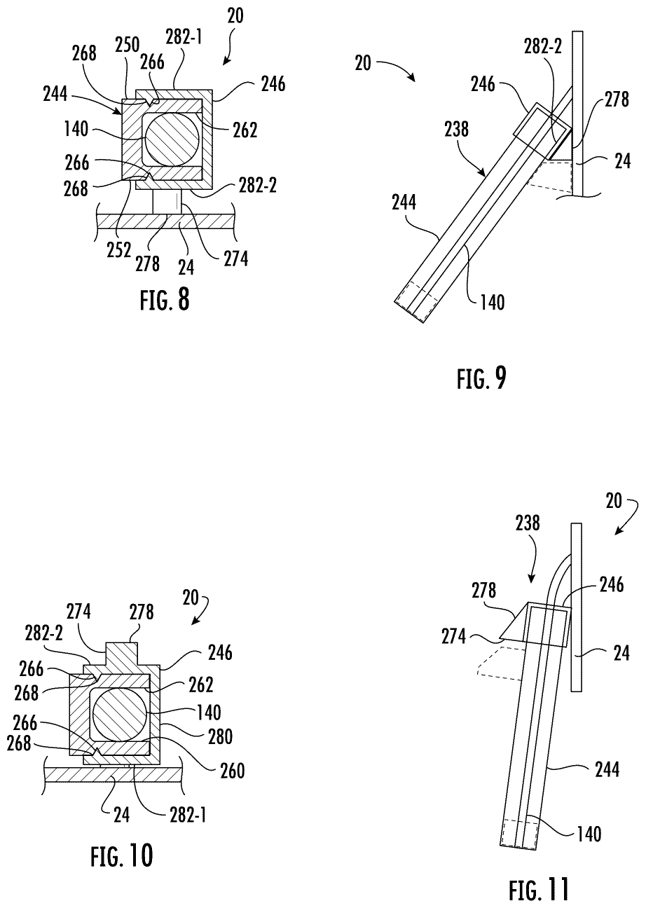

As shown by FIGS. 8 and 9, in the example illustrated, core sheath 244 comprise a U-shaped body 248 having top 250, a bottom 252, an inner side 254 and an outer side 256. When sheath 244 is mounted to core 140 and is hanging from waist belt 24, top 250 faces in a direction away from waist belt 24 and away from the person wearing waist belt 24. Conversely, when sheath 244 is mounted to core 140 and is hanging from waist belt 24, bottom 252 faces in a direction towards waist belt 24 and towards the person wearing waist belt 24.

Body 248 further comprises a groove 258 extending into outer side 256. In the example illustrated, groove 258 extends along the outer side 256 of sheath 244, wherein articles attached to the gear loop 238 extend over and in contact with top 250 of sheath 244. In the illustrated example, opening 262 of groove 258 has a width equal to or greater than the width of interior 260 to facilitate easier insertion of core 140 into groove 258. In other implementations, similar to sheath 144, groove 258 has an interior 260 sized to receive core 140 and a mouth 262 having a width less than that of the interior and less than the diameter or width of core 140, wherein at least portions of sheath 244 along mouth 262 are resiliently flexible so as to flex and bend when core 140 is being inserted into interior 260 through mouth 262. Once core 140 has been inserted into interior 260, such portions along mouth 262 resiliently return to their initial shape to maintain core 140 in interior 260 until core retainers 246 can more securely retain core 140 in place.

Core retainers 246 comprise structures configured to selectively retain core 140 withing core sheath 244. Each of core retainers 246 is U-shaped or is in the shape of a rounded or squared horseshoe. Each of core retainers 246 comprises a mouth covering portion 280 and a pair of sheath mounting arms 282-1, 282-2 (collectively referred to as arms 282). Arms 282 extend from mouth covering portion 280 and are configured to extend along top 250 and bottom 252 of core sheath 244. In other implementations, core retainers 246 may have other shapes or configurations.

In the example illustrated, core retainers 246 are located at opposite ends of core sheath 244. In other implementations, core retainers 246 may be replaced with a single core sheath that extends across a midpoint of sheath 244. In some implementations, a single core retainer 246 that extends from one end to the other end of sheath 244 may be used.

Each of core retainers 246 is configured to extend across and at least partially cover mouth 262 to inhibit core 140 from exiting sheath 244 through mouth 262. In the example illustrated, each of core retainers 246 is releasably snapped in place across mouth 262. In the example illustrated, arms 282 of each of core retainers 246 comprises opposing male projections 266 which snap into corresponding female recesses 268 formed on the exterior of body 248 of sheath 244. In the example illustrated, male projections 266 extend from inwardly facing surfaces arms 282 while female recesses 268 are located along exterior portions of top 250 and bottom 252 of sheath 244. Each of core retainers 246 is resiliently flexible to facilitate deformation or bending of such arms 282 to withdraw projections 266 from recesses 268, permitting sheath 244 to be repositioned or moved so as to uncover mouth 262, permitting sheath 244 to be separated from core 140.

In the example illustrated, each of core retainers 246 is completely separable from sheath 244. As a result, core retainers 246 may be repaired or replaced as needed. In other implementations, each of core retainers 246 (or the single core retainer when provided) may be movably secured to sheath 244 when moved to a mouth opening position so as to not be detached from sheath 144. For example, in some implementations, each of core retainers 146 may be connected to sheath 144 by a flexible tether 170 (shown in broken lines) so as to dangle from sheath 144 when not snapped to sheath 144. Such a tether 170 may prevent core retainers 146 from being dropped or otherwise lost. In some implementations, the tethers 170 may be integrally formed as part of a single unitary body with their respective core retainers 146. In other implementations, tethers 170 and may be co-molded with core retainers 146 or bonded, welded or otherwise connected to core retainers 146.

Each of core retainers 246 comprises a standoff 274 projecting or extending from arm 282-2. Standoff 274 comprises a structure projecting from the bottom 252 that is configured to butt against an exterior face of waist belt 24 so as to hold sheath 244 at an outwardly angled position extending away from waist belt 24. In the example illustrated, standoff 274 comprises a ramp surface 278 that contacts waist belt 24 so as to support one sheath 244 at an outwardly angled position as shown in FIG. 9. In other implementations, standoff 274 may have other shapes and configurations. For example, standoff 274 may comprise a finger or other on-ramp projection. Because standoff 274 spaces sheath 244 from waist belt 24, articles suspended by gear loop 238 are held away from waist belt 24 and away from the body the person wearing waist belt 24.

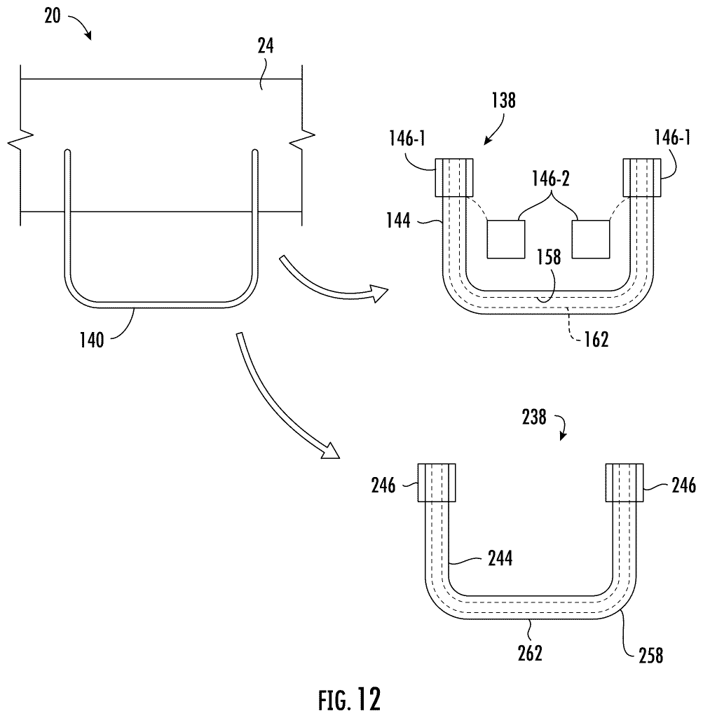

As shown by FIGS. 10 and 11, each of core retainers 246 are configured to be flipped from a first state or position in which arm 282-2 faces waist belt 24 (as shown in FIGS. 8 and 9) to a second state of in which arm 282-2 (and the associated standoff 274) alternatively face away from waist belt 24 as shown in FIGS. 10 and 11. When flipped to the position shown in FIGS. 10 and 11, standoff 274 no longer abuts waist belt 24, permitting gear loop 238 to hang closer to waist belt 24 and closer to the body of the person wearing waist belt 24. When hung closer to the body the person wearing waist belt 24, gear loop 238 may reduce a likelihood of the gear loop 238 inadvertently catching on external objects. In the example illustrated, each of core retainers 246 utilizes the same projections 266 and the same recesses 268 for securing core retainer 246 two core sheath 244 and the first state and the second state.

In some implementations, one or both of core retainers 246-1, 246-2 may be releasably secured to sheath 244 by a tether. In some implementations, both of core retainers 146-1 and 146-2 may be joined to sheath 144 by respective tethers 170.

FIG. 12 illustrates portions of an example harness 20 with core 140 and each of the removed core sheaths 144 and 244 with their associated core retainers 146 and 246, respectively, separated from core 140 and from waist belt 24. As shown by FIG. 12, in some implementations, harness 20 may be provided as a kit, wherein the user may select utilize either core sheath 144 with its core retainers 146 or core sheath 244 with its core retainers 246 with core 140. To form gear loop 138, core retainers 146 are separated from sheath 144 and sheath 144 is positioned over and about or along core 140. Thereafter, core retainers 146 may be snapped otherwise secured to sheath 144, extending across mouth 162 to secure core 140 within groove 158 and to secure sheath 144 along core 140. As discussed above, a person may selectively choose to use either core retainer 146-1 or core retainer 146-2 depending upon whether the person desires to hang the gear loop 138 in a spaced position similar to that shown in FIG. 4 or the more closely downwardly hang position shown in FIG. 6.

To form gear loop 238, core retainers 246 are separated from sheath 244 and sheath 244 is positioned over and about or along core 140. Thereafter, core retainers 246 may be snapped or otherwise secured to sheath 244, extending across mouth 262 to secure core 140 within groove 258 and to secure sheath 244 along core 140. As discussed above, a person may selectively flip core retainers 246 depending upon whether the person desires to hang the gear loop 238 in a spaced position similar to that shown in FIG. 9 or the more closely downwardly hanging position shown in FIG. 11.

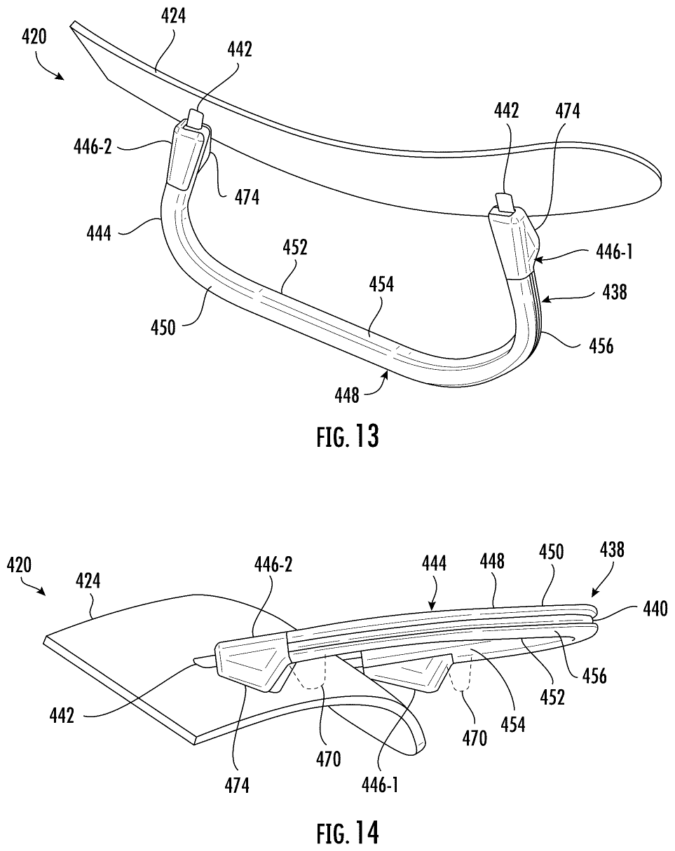

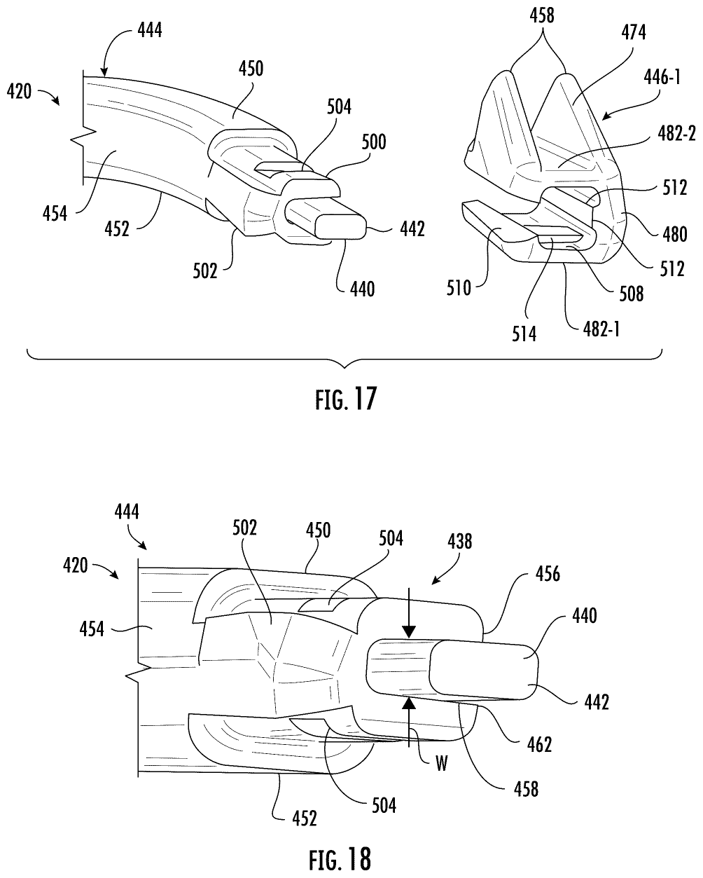

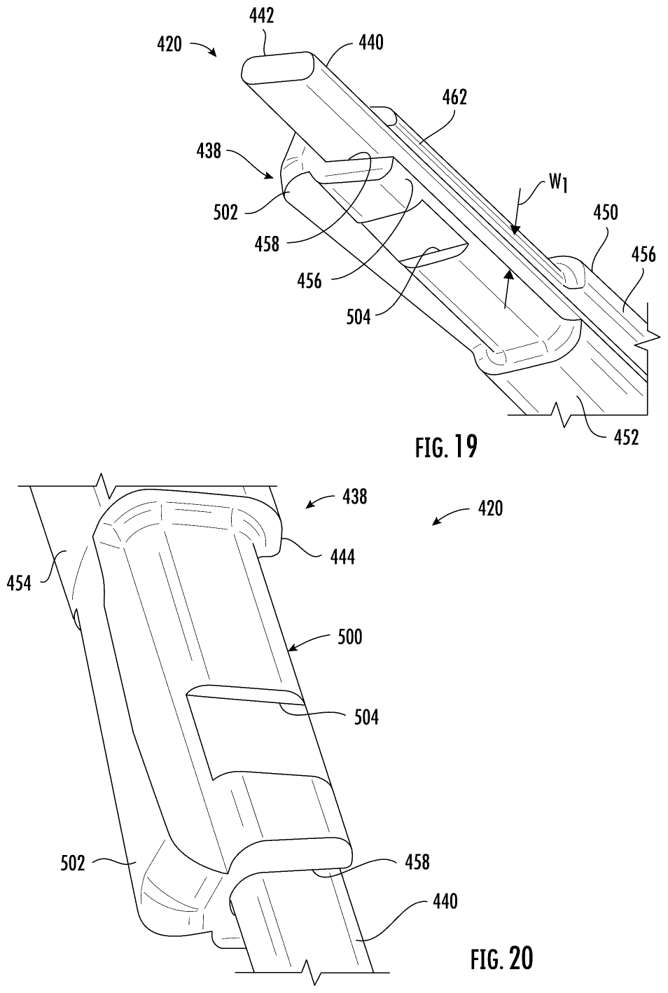

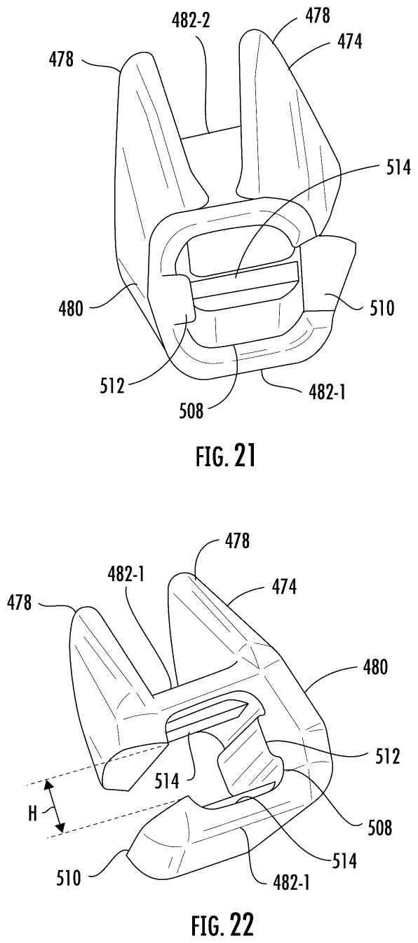

FIGS. 13-26 illustrate portions of an example harness 420. As shown by FIGS. 13 and 14, Harness 420 comprises waist belt 424 which comprises gear loop 438. Those remaining components of harness 420 and waist belt 424 are shown in FIGS. 1A and 1B and are described above. As should be appreciated, harness 20 may include multiple gear loops 438 supported by waist belt 424. Likewise, waist belt 424 is schematically illustrated for purposes of illustration. As should be appreciated, waist belt 424 may have other configurations, such as additional layers or padding, straps, shapes, or other constructions and the like.

Like waist belt 24, waist belt 424 is configured to support leg loops 26 from the waist of a person wearing harness 420. Waist belt 424 is further configured to be attached to a tether, rope, cable or other flexible line from which waist belt 424 may be suspended from an upper support to limit an extent to which waist belt 24 and the person wearing harness 420 may fall from the upper support. In addition to the example gear loop 438, waist belt 424 may comprise wide band portion 30, narrow extension portions 32-1, 32-2 (collectively referred to as narrow extension portions 32), connector 34, tether support line connectors 36, each of which is shown and described above with respect to harness 20.

Gear Loop 438 is functionally similar to gear loop 238 described above. FIG. 15 is an exploded perspective view of the portion of harness 420 shown in FIGS. 13 and 14. As shown by FIG. 15, gear loops 438 comprises structural core 440, core sheath 444 and core retainers 446-1 and 446-2.

Structural core 440 comprises an elongate member which serves as the spine for gear loop 438. Structural core 440 hangs from waist belt 424. In the example illustrated, structural core 440 has end portions 442 secured to waist belt 24 by stitching, welds, adhesives or the like. In the example illustrated, structural core 140 may comprise elongate flexible cord or strap having opposite ends 442 secured to waist belt 24 at spaced locations. The cord or strap may have a length within the range of 10 to 30 cm. The structural core 440 can be formed of material similar to structural core 140. In some implementations, the structural core 140, 440 can have tensile strength of at least 100 Newtons. In other implementations, the structural core 140, 440 can have tensile strength within the range of 100 to 3000 Newtons.

In some implementations, core 440 is sufficiently flexible such that it takes the shape of core sheath 444 when core sheath 444 receives core 440. In other implementations, core 440 may be sufficiently rigid with a predefined shape corresponding to the shape of core sheath 444. In other implementations, core 440 may be formed from other materials and have other configurations.

Core sheath 444 and core retainers 446 form a removable gear loop core cover system. Core sheath 444 comprises an outer covering configured to at least partially surround and receive core 440. Core sheath 444 has a degree of rigidity or stiffness greater than that of core 440 and/or is formed from material having a greater degree of abrasion resistance as compared to core 440. Core sheath 144 releasably are removably receives core 440. As a result, core sheath 444 may be separated from core 440 for repair, replacement or exchange with a differently configured course sheath 144. Core sheath 444 may be formed from a recyclable material, such as a thermoplastic polyurethane. In other implementations, the core sheath 444 can be formed of one or more of a nylon, other thermoplastic materials, a polypropylene, a polyurethane, a polyvinyl chloride, wood, aluminum and combinations thereof. As a result, in such implementations, rather than being disposed of, core sheath 444 may be independently reused or recycled when separated from harness 420. In some implementations, core sheath 444 is formed from a material such as nylon, polypropylene and polyvinyl chloride.

As shown by FIGS. 14, 15, 18 and 19, in the example illustrated, core sheath 444 comprise a U-shaped body 448 having top 450, a bottom 452, an inner side 454 and an outer side 456. As shown by FIGS. 13 and 14, when sheath 444 is mounted to core 440 and is hanging from waist belt 424, top 450 faces in a direction away from waist belt 424 and away from the person wearing waist belt 424. Conversely, when sheath 444 is mounted to core 440 and is hanging from waist belt 424, bottom 452 faces in a direction towards waist belt 424 and towards the person wearing waist belt 424.

Body 448 further comprises a groove 458 extending into outer side 456. In the example illustrated, groove 458 extends along the outer side 456 of sheath 444, wherein articles attached to the gear loop 438 extend over and in contact with top 450 of sheath 444. In the illustrated example, opening or mouth 462 of groove 458 has a width W1 (shown in FIG. 19) equal to or greater than the width W2 (shown in FIG. 18) of interior 460 to facilitate easier insertion of core 440 into groove 458. In other implementations, similar to sheath 144, groove 458 has an interior 460 sized to receive core 440 and a mouth 462 having a width less than that of the interior and less than the diameter or width of core 440, wherein at least portions of sheath 444 along mouth 462 are resiliently flexible so as to flex and bend when core 440 is being inserted into interior 460 through mouth 462. Once core 440 has been inserted into interior 460, such portions along mouth 462 resiliently return to their initial shape to maintain core 440 in interior 460 until core retainers 446 can more securely retain core 440 in place.

End portions of sheath 444 are configured to facilitate releasable connection of core retainers 446 such that core retainers 446 maintain core 440 within groove 458. In the example illustrated, end portions of sheath 444 are configured to facilitate a releasable snap connection of core retainers 446 to end portions of sheath 444, wherein one or both of such end portions and core retainers 446 include resiliently flexible portions that resiliently bend or flex during mounting of core retainers 446 to such end portions of sheath 444 and which resiliently return to their initial shapes such that male portions or projections are aligned with and mate or fit within corresponding female portions or recesses to axially retain core retainers 446 on and portions of sheath 444. In the example illustrated, such end portions of core retainers also resiliently flex during mounting of core retainers 446 on such end portions of sheath 444 and resiliently return to a default shape once core retainers 446 are fully positioned on such end portions of sheath 444 such that core retainers 246 sufficiently wrap about such end portions to radially retain core retainers 246 on end portions of sheath 444.

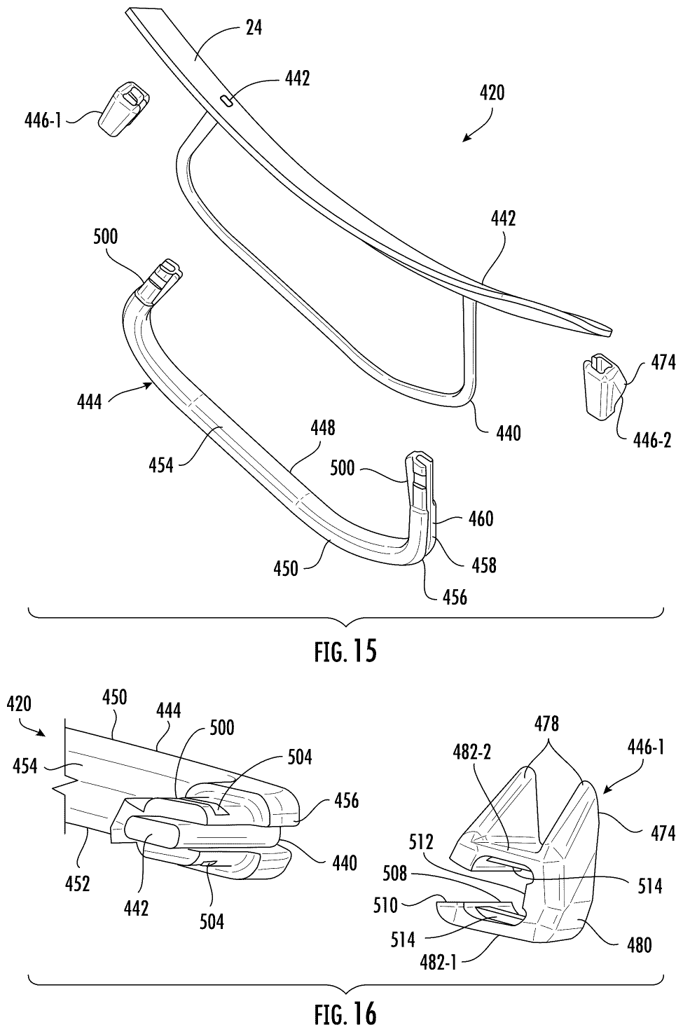

As shown by FIGS. 16-20, each of the end portions of sheath 444 comprises a neck 500 and an inner neck projection 502. Neck 500 comprise a necked down portion of sheath 444 at each of the end portions of sheath 444. Neck 500 comprises a pair of opposite transverse detents 504. As will be described hereafter, core retainers 446 flex to snap about neck 500 to be radially retained in place with projections being received within detents 504 to secure retainers 446 axially in place.

Inner neck projection 502 projects from neck 500 along the inner side of sheath 444. Inner neck projection 502 has an inner surface that is substantially flush with inner side 454 of the remainder of sheath 444. As result, the inner side of sheath 444 omits any large recesses where articles hanging from gear loop 438 might otherwise catch. In some implementations, inner neck projection 502 may be omitted.

FIGS. 16-17 and 21-22 illustrate one of core retainers 446 in more detail. Core retainers 446 comprise structures configured to selectively retain core 440 within sheath 444. Each of core retainers 446 is U-shaped or is in the shape of a rounded or squared horseshoe. Each of core retainers 446 comprises a mouth covering portion 480 and a pair of sheath mounting arms 482-1, 482-2 (collectively referred to as arms 482). Arms 482 extend from mouth covering portion 480 and are configured to extend along top 450 and bottom 452 of core sheath 444. In other implementations, core retainers 446 may have other shapes or configurations.

In the example illustrated, core retainers 446 are located at opposite ends of core sheath 444. In other implementations, core retainers 446 may be replaced with a single core sheath that extends across a midpoint of sheath 444. In some implementations, a single core retainer 446 that extends from one end to the other end of sheath 444 may be used.

Each of core retainers 446 is configured to extend across and at least partially cover mouth 462 to inhibit core 440 from exiting sheath 444 through mouth 462. In the example illustrated, each of core retainers 446 is releasably snapped in place across mouth 462. In the example illustrated, each of core retainers 446 has a substantially C-shaped cross-section forming a neck receiving channel 508 having a mouth 510. Mouth 510 has a height H less than the internal height of the channel 508 and less than a corresponding height of 500. As result, arms 422 wrap about and across the top 450 in the bottom 452 of neck 500 and partially extend across the inner side 454 of neck 500 until abutting projection 502 when core retainer 446 is positioned about neck 500. The engagement of those portions of arms 482 and the inner side 454 of neck 500 radially retains core retainer 446 on neck 500 and across groove 458.

As further shown by such figures, each of core retainers 446 further comprises a groove plug 512 and a pair of transverse projections 514. Groove plug 512 comprise a bar or other projection projecting from groove covering wall 480 into channel 508 substantially opposite to mouth 510. Groove plug 512 is sized to fit within the mouth 462 of groove 458 such that sheath 444 and plug 512 surround all sides of core 440, securely capturing core 440. When received within mouth 462 of groove 458, groove plug 512 resists rotation of retainer 446 about the centerline or longitudinal axis of neck 500. In some implementations, groove plug 512 may be omitted or have other configurations.

Projections 514 transversely extend channel 508 along inner surfaces of arms 482. Projections 514 are sized to be received within the corresponding transverse detents 504 provided in neck 500 of sheath 444. Projections 514 cooperate with detents 504 to axially retain core retainers 446 on neck 500 at each of the end portions of sheath 444.

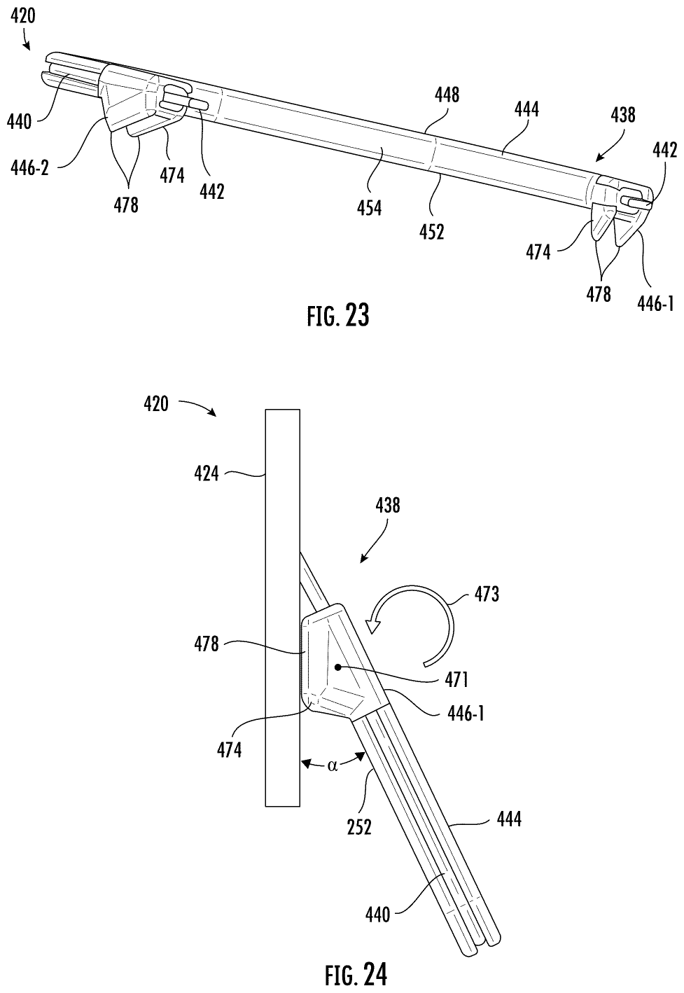

FIG. 23 illustrates an end view of sheath 444 with core retainers 446 snapped onto the respective neck 500. As shown by FIG. 23, mouth 510 receives neck projection 502. Core 440 is captured on three sides of neck 500 and on an outer side by plug 512.

In the example illustrated, each of core retainers 446 is completely separable from sheath 444. As a result, core retainers 446 may be repaired or replaced as needed. In other implementations, each of core retainers 446 (or the single core retainer when provided) may be movably secured to sheath 444 when not enclosing neck 500 so as to not be detached from sheath 144. For example, in some implementations, each of core retainers 446 may be connected to sheath 444 by a flexible tether 470 (shown in broken lines) so as to dangle from sheath 444 when not snapped to sheath 444. Such a tether 470 may prevent core retainers 146 from being dropped or otherwise lost. In some implementations, the tethers 470 may be integrally formed as part of a single unitary body with their respective core retainers 446. In other implementations, tethers 470 and may be co-molded with core retainers 446 or bonded, welded or otherwise connected to core retainers 446.

Each of core retainers 446 comprises a standoff 474 projecting or extending from arm 482-2. Standoff 474 comprises a structure projecting from the bottom 452 that is configured to butt against an exterior face of waist belt 424 so as to hold sheath 444 at an outwardly angled position extending away from waist belt 424 as shown in FIG. 24. In some implementations, the core retainers 446 project the sheath 444 from the waist belt 424 at an outward angle a within the range 5 to 80 degrees. In other implementations, the outward angle α is within the range of 15 to 45 degrees. In the example illustrated, standoff 474 comprises a pair of ramp surfaces 478 that contacts waist belt 424 so as to support sheath 444 at an outwardly angled position as show. In other implementations, standoff 474 may have other shapes and configurations. For example, standoff 474 may comprise a single ramp, a finger or other non-ramp projection. Because standoff 474 spaces sheath 1444 from waist belt 424, articles suspended by gear loop 438-1 are held away from waist belt 424 and away from the body the person wearing waist belt 424. In some implementations, the core retainers 446 are releasably coupled to the structural core 440 and releasably coupled to the waist belt 424. The core retainers 446 can be attached to the core 440 by a press-fit connection, a snap fit connection or other releasable fastening connection.

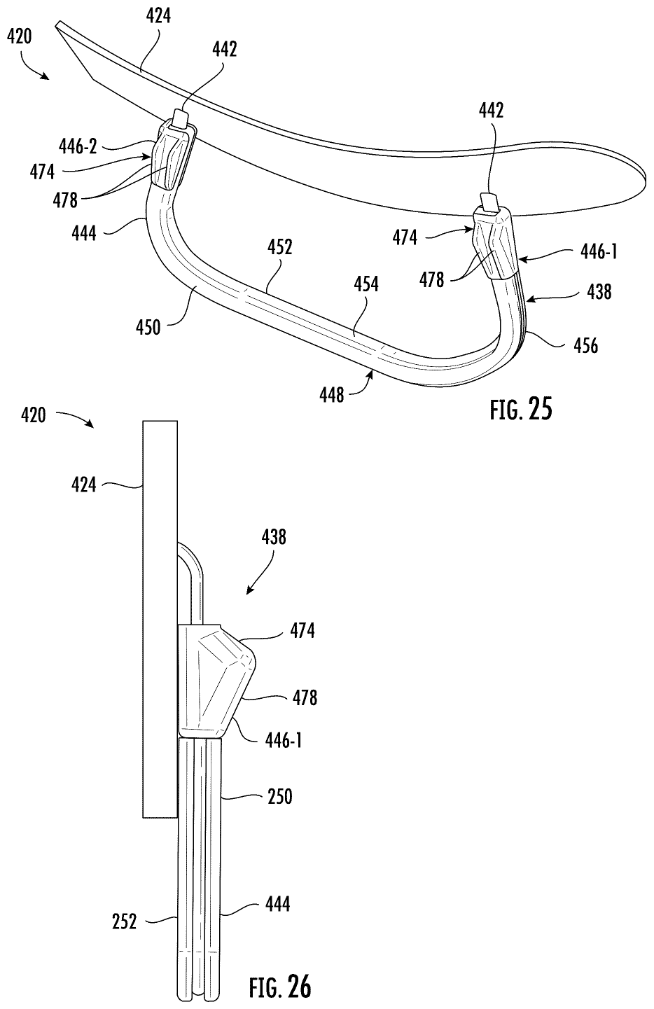

As shown by FIGS. 25 and 26, each of core retainers 446 are configured to be flipped from a first state or position in which ramp surfaces 478 shown in FIGS. 13 and 24 face waist belt 424 to a second state or position in which ramp surfaces 478 alternatively face away from waist belt 424. In the example illustrated, the top interior surface of channel 508 and the bottom interior surface of channel 508 (when mouth 510 is facing in a sideways direction) are similar or identical. Likewise, the surface on the top of neck 500 and the surface on the bottom of neck 500 (when groove 458 is facing in a sideways direction) are similar or identical. This symmetry between the top and bottom surfaces of channel 508 and the exterior of neck 500 facilitates the flipping of each of core retainers 446 to selectively position core retainers 446 in either the standoff position shown in FIG. 24 or the vertical hang position shown in FIG. 26. When flipped to the vertical hang position shown in FIGS. 25 and 26, standoffs 474 no longer abuts waist belt 424, permitting gear loop 438 to hang closer to waist belt 424 and closer to the body of the person wearing waist belt 424. When hung closer to the body of the person wearing waist belt 424, gear loop 438 may reduce a likelihood of the gear loop 438 inadvertently catching on external objects.

To “flip” core retainers 446, the core retainers 446 are first disconnected from sheath 444 by pulling arms 42 apart to widen mouth 510 to a sufficient degree such that neck 500 may be pulled through mouth 510. After each of core retainers 446 have been separated from sheath 444, they may be reversed or flipped and remounted to the respective next of the end portion of sheath 444. In particular, each of core retainers 446 is flipped by being rotated about axis 471 in the direction indicated by arrow 473 shown in FIG. 24. Following such flipping, each retainer 446 is mounted about core 440 and sheath 444 in the position shown in FIG. 26. As described above, in the standoff state shown in FIG. 24, standoffs 474 project away from bottom 452 of sheath 444 towards waist belt 424. When flipped to the vertical hang position shown in FIG. 26, core retainers 446 are mounted to neck 500 such that standoff 474 alternatively project beyond and away from time to 50 of sheath 444, in a direction away from waist belt 424. In both positions, plug 512 continues to extend within mouth 462 of groove 458 and detents 504 continue to receive projections 514, albeit the other of projections 514.

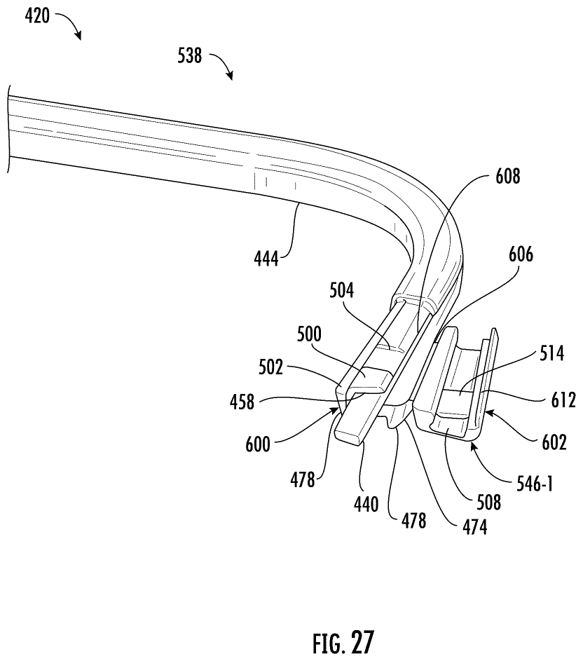

FIG. 27 is a fragmentary perspective view illustrating one side of an example gear loop 538, the other side mirroring the side shown. Gear loops 538 may be employed as gear loops 38 of either of the example harnesses shown in FIG. 1A or 1B. Gear loop 538 comprises core 440 (described above) and an example removable gear loop core cover system formed by core sheath 444 (described above) and core retainer 546-1.

Core retainer 546-1 is identical to core retainer 446 described above except that core retainer 546 is bifurcated into sheath portion 600 and hinged portion 602. As with core retainer 446-1, core retainer 546-1 is releasably connected to the waist belt of the harness 420. Core retainer 546-1 is separated from the waist belt when core sheath 444 is separated from the waist belt. In contrast to core retainer 446-1, core retainer 546-1 remains connected to core sheath 444 when the core sheath 444 is released or separated from the waist belt. Those remaining components or features of core retainer 546-1 that correspond components or features of retainer 446-1 are numbered similarly.

Sheath portion 600 is integrally formed as part of a single unitary body with core sheath 444. In such implementations, sheath portion 600 may be molded with core sheath 444 as a single unitary body. Sheath portion 600 replaces the lower half of the end portions of sheath 444, eliminating the lower half of neck 500 with its lower transverse detent 504 and the lower half of inner neck projection 502. The upper half of the end portion of sheath 444 remains the same, comprising the upper half of neck 500 with its upper transverse detent 504 and the upper half of inner neck projection 502. The lower downwardly facing side of sheath portion 600 comprises standoff 474 (similar to that as shown on retainer 446-1 in FIG. 23).

Hinged portion 602 is integrally formed as part of a single unitary body sheath portion 600 (and sheath 444) and is joined to sheath portion 600 by a living hinge 606. Hinge 606 is a layer of a polymeric material sufficiently thin so as to be flexible, facilitating repeated bending or pivoting of hinged portion 602 about hinge 606 between the open state as shown and a closed state. In other implementations, hinge 606 may be replaced with a flexible tether or may be replaced with a mechanical hinge.

In the open position or state shown in FIG. 27, hinged portion 602 is pivoted away from sheath portion 600 so as to expose an axially extending elongate opening or slot 608 serving as the mouth for the interior of groove 458. As result, when hinged portion 602 is in the open state shown, core 440 may be withdrawn from groove 458 through slot 608. Withdrawal of core 440 from groove 458 enables sheath 444 to be separated from core 440 and enables sheath 444 and core retainer 546-1 to be separated from the waist belt of the harness 420.

Hinged portion 602 facilitates locking and retention of core 440 within groove 458. Hinged portion 602 Is identical to the upper half of retainer 446-1 (as shown in FIG. 23). Hinged portion 602 comprises the upper half of the neck receiving channel 508 and the upper transverse projection 514. The upper half of the neck receiving channel 508 wraps about the upper half of neck portion 500 when hinged portion 602 is pivoted to the closed position. In the closed position, the upper transverse projection 514 is received within the upper transverse detent 504. In the closed position, the edge or lip 612 of hinged portion 602 bears against the upper half of neck projection 502 so as to be flush along the inner side of sheath 444. When retainer 546-1 is in the closed state, retainer 546-1 has an overall shape and configuration similar to that of retainer 446-1 shown in FIG. 23.

Although not shown, the other side of gear loop 538 is also provided with another core retainer similar to core retainer 546-1 but mirroring retainer 546-1 (similar to how core retainer 446-2 mirrors core retainer 446-1 in FIG. 23). In other words, while core retainer 546 pivots from a closed state to the illustrated open state in a clockwise direction about hinge 606, the core retainer on the other side of sheath 44 pivots from a closed state to an open state in a counterclockwise direction about a corresponding hinge 606. Portions 602 pivot outwardly away from their associated slots 608 that communicate with the interior of the outwardly facing groove 458.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1.

2. A harness comprising:
a waist belt; and
a harness gear loop comprising:
a structural core having spaced portions secured to the waist belt and a central portion between the spaced portions;
a core sheath comprising a groove configured to removably receive the central portion of the structural core while the core sheath extends along and about the structural core; and
a core retainer releasably coupled to the waist belt, the core retainer configured to:
selectively retain the core sheath along and about the structural core with the central portion of the structural core residing within the groove; and
selectively release the core sheath from the structural core with the central portion removed from the groove while the spaced portions remain secured to the belt.

3.

4. The harness of claim 1, wherein core sheath has an inwardly facing surface and an outwardly facing surface and wherein the groove extends inwardly into the outwardly facing surface.

5.

6. The harness of claim 1, wherein the core retainer comprises:
a first core retainer proximate a first end of the core sheath; and
a second core retainer proximate a second end of the core sheath.

7.

8. The harness of claim 3, wherein the first core retainer is releasably attached to the first end and wherein the second core retainer is releasably attached to the second end.

9.

10. The harness of claim 4, wherein the first core retainer is resiliently snapped about the first end of the core sheath and wherein the second core retainer is resiliently snapped about the second end of the core sheath.

11.

12. The harness from claim 5, wherein each of the first core retainer and the second core retainer comprises a first face that is ramped and a second face that is flat and wherein the first core retainer and the second core retainer are each configured to be selectively snapped to the core sheath in either of a first orientation relative to the core sheath in which the first face faces downwardly and a second orientation relative to the core sheath which the second face faces downwardly.

13.

14. The harness of claim 4, wherein the first core retainer and the second core retainer each comprises a first face that is ramped and a second face that is flat and wherein the first core retainer and the second core retainer are each configured to be selectively releasably attached to the core sheath in either of a first orientation relative to the core sheath in which the first face faces downwardly and a second orientation relative to the core sheath which the second face faces downwardly.

15.

16. The harness of claim 3, wherein the first core retainer and the second core retainer each comprises a first face that is ramped and a second face that is flat and wherein the core sheath configured to be positioned along and about the structural core in a first orientation relative to the structural core in which the first face faces downwardly and a second orientation relative to the structural core in which the second face faces downwardly.

17.

18. The harness of claim 3, wherein the first core retainer is fixedly connected to the first end and is movable relative to the first end between a first state in which the first core retainer retains the core sheath along and about the structural core with the central portion of the structural core residing within the groove and a second state in which the core sheath is released from the structural core with the central portion removed from the groove while the spaced portions remain secured to the belt.

19.

20. The harness of claim 1, wherein the groove comprises an interior and an entrance, wherein the interior has a first width and when the entrance has a second width greater than or equal to the first width.

21.

22. The harness of claim 1, wherein the core sheath is formed from a material selected from a group of materials consisting of nylon, thermoplastic materials, polypropylene, polyurethane, polyvinyl chloride, wood, aluminum and combinations thereof.

23.

24. The harness of claim 1, wherein the core sheath has an asymmetrical cross-sectional shape, wherein the groove has a first edge and a second edge and wherein the core sheath is selectively positionable along and about the structural core in a first orientation in which a first edge extends above the second edge and a second orientation which the first edge extends below the second edge.

25.

26. A removable gear loop core cover system for use with a harness having a waist belt and a structural core having spaced portions secured to the belt and a central portion between the spaced portions, the removable gear loop core cover system comprising:
a U-shaped core sheath comprising a groove configured to removably receive the central portion of the structural core while the core sheath extends along and about the structural core; and
a core retainer releasably coupled to the waist belt and configured to:
selectively retain the core sheath along and about the structural core with the central portion of the structural core residing within the groove; and
selectively release the core sheath from the structural core with the central portion removed from the groove while the spaced portions remain secured to the belt.

27.

28. The removable gear loop core cover system of claim 13, wherein the core retainer comprises:
a first core retainer proximate a first end of the core sheath; and
a second core retainer proximate a second end of the core sheath.

29.

30. The removable gear loop core cover system of claim 14, wherein the first core retainer is releasably attached to the first end and wherein the second core retainer is releasably attached to the second end.

31.

32. The removable gear loop core cover system of claim 15, wherein the first core retainer comprises a first end cap resiliently snapped about the first end of the core sheath and wherein the second core retainer comprises a second end cap resiliently snapped about the second end of the core sheath.

33.

34. The removable gear loop core cover system from claim 16, wherein each of the first core retainer and the second core retainer comprises a first face that is ramped and a second face that is flat and wherein the first core retainer and the second core retainer are each configured to be selectively snapped to the core sheath in either of a first orientation relative to the core sheath in which the first face faces downwardly and a second orientation relative to the core sheath which the second face faces downwardly.

35.

36. The removable gear loop core cover system of claim 15, wherein the first core retainer and the second core retainer each comprises a first face that is ramped and a second face that is flat and wherein the first core retainer and the second core retainer are each configured to be selectively releasably attached to the core sheath in either of a first orientation relative to the core sheath in which the first face faces downwardly and a second orientation relative to the core sheath which the second face faces downwardly.

37. The removable gear loop core cover system of claim 14, wherein the first core retainer is fixedly connected to the first end and is movable relative to the first end between a first state in which the first core retainer retains the core sheath along and about the structural core with the central portion of the structural core residing within the groove and a second state in which the core sheath is released from the structural core with the central portion removed from the groove while the spaced portions remain secured to the belt.

38.

39. The removable gear loop core cover system of claim 13, wherein the groove comprises an interior and an entrance, wherein the interior has a first width and when the entrance has a second width greater than or equal to the first width.
